(19) United States
(12) Patent Application Publication
(10) Pub. No.: US 2003/0047831 A1
(43) Pub. Date: Mar. 13, 2003

(54) Method for granulating thermoplastic polymers

(76) Inventors: Michael Witt, Rotorua (NZ); Rainer Anderlik, Heidelberg (DE); Jurgen Hofmann, Ludwigshafen (DE); Thomas Kessler, Schifferstadt (DE); Farid Rizk, Neuhofen (DE); Wolfgang Bickel, Grunstadt (DE)

Correspondence Address: CONNOLLY BOVE LODGE & HUTZ, LLP, 1220 N MARKET STREET, P O BOX 2207, WILMINGTON, DE, 19899

(21) Appl. No.: 10/221,706

(22) PCT Filed: Mar. 13, 2001
(86) PCT No.: PCT/EP01/02778

(30) Foreign Application Priority Data
Mar. 21, 2000 (DE) 100 13 948.5

(51) Int. Cl. B29B 9/00

(52) U.S. Cl. 264/142; 264/37.14

(57) ABSTRACT

In a method for granulating thermoplastic polymers, in particular thermoplastic polyolefins, the polymer powder prepared in the polymerization reactor is melted and homogenized in an extruder, then forced through an extrusion die and granulated. In accordance with the invention, the polymer powder is subjected to heat treatment before introduction into the extruder, resulting in the introduction of the polymer powder into the extruder being carried out at an elevated powder temperature. The invention is particularly suitable for the granulation of polyethylene or polypropylene.

The present invention relates to a method for granulating thermoplastic polymers, in particular thermoplastic polyolefins, in which the polymer powder prepared in the polymerization reactor is melted and homogenized in an extruder, then forced through an extrusion die and then cooled and comminuted.

The granulation of thermoplastic polymers is known and serves the purpose of homogenization of the polymer and, if desired, incorporation of additives, such as stabilizers, colorants, agents for improving the mechanical properties, fillers and the like, into the polymer. In addition, handling of the thermoplastic polymers during transport and further processing can be considerably improved by granulation compared with handling of powders.

Besides direct coupling of polymerization and granulation, in which the polymer powder normally still has residual heat from the polymerization process and for this reason is fed to the extruder at elevated temperature, the addition of polymer powder to the extruder at a temperature which corresponds to the ambient temperature is usual, in particular, in so-called compounding processes. This is due, in particular, to interim storage of the polymer powder in silos and the transport methods via pneumatic conveying systems, where complete cooling of the powder to ambient temperature generally occurs.

Thus, as a general rule, during compounding polymer powder is fed to the extruder as bulk material at ambient temperature. The powder here must be heated more and more by mechanical friction forces in the extruder feed zone and finally melted step by step. However, the known granulation methods are still unsatisfactory with respect to their throughput, the associated degree of stress on the machine and the product quality of the granules.

The object of the present invention was to indicate a method for granulating thermoplastic polymers in which the effectiveness of homogenization during granulation is increased for the same throughput or in which the degree of stress on the machine can be reduced, which results in reduced susceptibility to repair and reduced down times, or in which the product throughput of existing granulation machines can be increased for the same homogenization performance.

This object is achieved by a method of the generic type mentioned at the outset, whose characterizing feature is to be regarded as that the polymer powder is subjected to heat treatment before introduction into the extruder, and that the introduction of the polymer powder into the extruder is carried out at an elevated powder temperature.

The heat treatment according to the invention is preferably carried out with such an intensity that the temperature of the polymer powder rises to a value in the range from 5 to 30 K below the melting point of the polymer, preferably in the range from 10 to 20 K.

The heat treatment according to the invention can be achieved in a wide variety of ways, for example the polymer powder can be heated using steam and subsequently dried using hot air or it can be passed through an externally heated pipe. In a particularly advantageous embodiment of the method according to the invention, the polymer powder is heated in a bulk-material heat exchanger, as described in the journal Chemie Technik (1999) No. 4, page 84. The mass flow rate here is controlled by a vibrating conveyor, and the polymer powder flows through heated metal plates.

The thermal energy needed for the heat treatment according to the invention can, in accordance with the invention, advantageously be provided by waste heat which is available inexpensively on the production site. A good example of waste heat of this type is the exothermic polymerization reaction, which liberates large amounts of heat. Alternatively, the thermal energy needed for the method according to the invention can also be provided at low cost from the cooling of other production plants.

Advantageous polymers which can be granulated particularly well using the method according to the invention have proven to be, in particular, standard polymers, such as polyolefins, polyesters or polyamides, but preferably polyethylene or polypropylene. In the case of polyethylene, the polymer powder temperature according to the invention during addition to the extruder is preferably in the range from 80 to 100° C., while in the case of polypropylene, a temperature of from 100 to 120° C. is particularly suitable.

The calculation example shown below is intended to describe the invention and its advantages more clearly to the person skilled in the art.

### EXAMPLE 1

(According to the Invention)

The amount of energy necessary to heat an HDPE powder from 20° C. to 100° C. is 42.4 kcal/kg of powder (source: “Spezifische Wärme von Niederdruck Polyethylen” [Specific heat of low-pressure polyethylene], H. Wilski, Kunststoffe 50 (5) 1960).

After conversion, this gives a value of 0.049 kWh/kg.

A granulation extruder having a capacity of 6 t/h requires a specific total energy input of 0.2 kWh/kg of HDPE if the powder has an initial temperature of 20° C. 0.05 kWh/kg thereof go to heating of the powder from 20 to 100° C., i.e. around 25%, based on the total amount. This reflects the maximum saving potential theoretically achievable, but in practice this cannot be achieved in full.

Given power costs of about 9.0 pfennigs per kWh per year, the above-mentioned granulation extruder causes operating costs at a level of DM 950,000. In the case of supply of polymer powder at a temperature of 100° C., these operating costs can be reduced by 20%. However, the energy of 0.05 kWh/kg must be introduced in another way, for example via very inexpensive steam (process heat).

For a granulation plant with an output of only 6 t/h, this gives rise to a potential saving of about DM 200,000 per year. In addition, the energy input reduced by 20% means a lower degree of stress on the machine and thus a longer life together with reduced repair costs.

If, on the other hand, the maximum possible throughput of the extruder is limited by the installed power, the output of the machine can in this case alternatively be increased by pre-warming of the polymer powder.

1. Method for granulating thermoplastic polymers, in which the polymer powder prepared in a polymerization reactor is melted and homogenized in an extruder, then forced through an extrusion die and granulated, the polymer powder being subjected to heat treatment before introduction into the extruder, characterized in that the introduction of the polymer powder into the extruder is carried out at a powder temperature in the range from 5 to 30 K below the melting point of the polymer, and in that the thermal energy needed for the heat treatment of the polymer powder is provided by waste heat which is available inexpensively on production sites.

2. Method according to claim 1, characterized in that the heat treatment is carried out in such a way that the temperature of the polymer powder rises to a value in the range from 10 to 20 K below the melting point of the polymer.

3. Method according to claim 1 or 2, characterized in that the polymer powder is heated using steam before introduction into the extruder and is subsequently dried using hot air or hot nitrogen.

4. Method according to one of claims 1 or 2, characterized in that the polymer powder is passed through an externally heated pipe before introduction into the extruder.

5. Method according one of claims 1 or 2, characterized in that the polymer powder is heated in a bulk-material heat exchanger before introduction into the extruder, with the mass flow rate being controlled by a vibrating conveyor and the polymer powder flowing through heated metal plates.

6. Method according to one of claims 1 to 5, characterized in that it is employed for the granulation of polyethylene or polypropylene.
